(19) United States
(12) Patent Application Publication
(10) Pub. No.: US 2013/0260993 A1
(43) Pub. Date: Oct. 3, 2013

(54) Agricultural Homeopathic Elements for Biocontrol

(71) Applicants: James Linden, Loveland, CO (US); Richard J. Stoner, II, Berthoud, CO (US)

(72) Inventors: James Linden, Loveland, CO (US); Richard J. Stoner, II, Berthoud, CO (US)

(21) Appl. No.: 13/432,984

(22) Filed: Mar. 28, 2012

(51) Int. Cl. A01C 1/06; A01N 43/16; A01P 1/00; A01N 59/26

(52) U.S. Cl. 504/100; 424/601; 514/55

(57) ABSTRACT

The liquid elicitor of chitin and chitosan and micronutrient trace elements of the present invention involves induced systemic resistance (ISR)/innate immunity responses within plants. Dilute solutions are applied to propagules (fractions of microgram per seed and/or plant), which causes natural biotic defense responses by seedlings and/or plants. The application may be as seed coating, irrigation water, and/or foliar spray, wherein propagules bioactivate systemic disease defenses against bacteria, fungi, insects and parasitic nematodes. Benefits include enhanced biocontrol of seed viability, seed germination, seedling vigor, plant growth, flowering and harvest yields for legumes, grains, potatoes, vegetables, fruits, trees, sugar beet, and grass. By nature, this homeopathic invention benefits the entire environment by being natural, biodegradable, and by promoting beneficial soil organisms. This new class of agricultural chemistry will ameliorate adverse effects of toxic pesticides through use of the present invention in integrated pest management (IPM) programs.

### CLAIM OF PRIORITY

The present invention claims priority under 35 USC 120 from U.S. non-provisional patent application Ser. No. 11/517,035, filed Sep. 7, 2006, of common inventorship herewith entitled, “Micronutrient Elicitor for Treating Nematodes in Field Crops” and U.S. non-provisional continuation-in-part patent application Ser. No. 12/931,560, filed Feb. 4, 2011, of common inventorship herewith entitled “Elicitors Comprising Chitin or Chitosan or Both and Micronutrient Trace Elements for Propagule Disease, Pathogen and Pest Control at Nanogram Scale, now abandoned.

### 1. TECHNICAL FIELD OF THE INVENTION

This invention relates to bioactive organic disease control techniques for eliciting plants to suppress disease, pathogens and pests in field crops and trees.

### II. BACKGROUND OF THE INVENTION

The present invention utilizes techniques that provide primary recognition of pathogen associated molecular patterns (PAMPs) by receptors in plant cell membranes and signal transduction to induce natural physiological chemical engines within plants. PAMP chitin and chitosan oligomers are defined as anions of minerals and as elicitors of these natural physiological processes. The focus of the invention is the suppression of plant environmental stresses and diseases, pathogens and pests, which infect crops, such as soybeans, wheat and corn under field conditions by innate immunity. This invention includes chitin and chitosan, which also boosts induced systemic resistance (ISR) in trees, such as conifers, to provide treated trees resistance against pine beetles and blue stain molds.

In any crop production endeavor, it has been desirable to produce yields not only in high quantities, but that are also disease-free. These goals can be either easily achieved or achieved with difficulty, depending upon the specific plant types involved. Often the farmer need only plant the beneficial specimens in a nurturing environment. The cultivars themselves then may develop relatively free from disease with little outside assistance. This can be especially true for cultivars or propagules that are reproduced through seed propagation. Some of the time, a seed coating is applied and acts as a protective environment, which allows the juvenile propagule not only to be stored relatively disease free, but also to begin its growth in a somewhat protected environment. The problem of disease control is, however, much more challenging for propagules that are vulnerable to attack by nematodes.

Commercial crops are vulnerable to a variety of diseases, and disease control can be acute. In spite of these needs, there is also a need to minimize the utilization of chemicals, chemically-formulated pesticides, chemically-formulated additives, and the like with respect to food production. It has become very desirable for crop production intended for consumptive use to be grown organically or as naturally as possible. Organic implies without employment of chemically-formulated substances or at least to be grown in an environment, which minimizes the utilization of unnatural effects such as the use of chemically-formulated pesticides (fungicides, insecticides and herbicides), genetically engineered changes, irradiation, and the like. While the desirability of a completely naturally grown product can rarely be debated, the actual implementation of these desires has, on a large scale; been very difficult to realize until the present invention. This has been especially true for crops susceptible to parasitic nematodes. The present invention is non-systemic in the traditional sense, in that the material is not absorbed or taken up by the propagule. The present invention provides the plant itself, by means of induced systemic resistance and innate immunity, with capabilities for controlling diseases, pathogens and insects. The present invention may have particular applicability to soybean, bean, pea, corn, sugar beets wheat, oats, barley, rice, clover, tomato, pepper and potato crops, as well as vegetables, grass, flowers, fruit, citrus and conifer trees.

As mentioned, the desire for disease control has existed for years. There still exist outbreaks of disease. Naturally, these vary in location and time. Basically, it simply has not been possible to completely eliminate the spread of disease through regulatory approaches. As markets have evolved, demands for disease-free crops have increased.

The more widely used approach to the problem of disease control has been very traditional—the use of pesticides. Often, this solution has not always been acceptable; consumers have expressed a desire for organically grown produce free of pesticides. In addition, the use of pesticides, although often fairly effective, has been accompanied by other problems. First, the pesticides need to be applied. This can be challenging in that broadcast application on a field basis may not provide the concentrated amount necessary at the particular plant. Second, to the extent the pesticide does not break down and remains in the soil, it may produce byproducts, or residual pesticide which can pose a problem of contamination. Thus pesticides can often result in unacceptable contamination of the remaining soils after the crop has been harvested. Contamination of the harvested product is also an issue for consumer safety. In addition, exposure to the applied pesticide causes much illness and many deaths among farm workers each year.

The present invention takes an entirely different approach to the problem of the disease control. It presents a system which utilizes naturally occurring, organic substances that are not chemically-formulated, are not harmful to the propagule and yet trigger that propagule's own natural defense mechanisms. Thus, the propagule itself is prompted to provide defensive substance(s) in the vicinity of the propagule. In the case a disease producing organism (bacterium, fungus and/or nematode) enters this vicinity, the disease is controlled even before the propagule may sense its presence. This is an entirely different approach from the main efforts in this field. By utilizing a known, naturally occurring trigger substance such as chitin and chitosan, the invention acts in a manner to intensely trigger the plant's natural defensive mechanisms. Although the stimulating substances may have been known for years, causing an intense stimulation by the present invention an entirely different and unexpected result is achieved.

As mentioned, others may have utilized the particular substances involved. Even those inventions, which had utilized the chitin and chitosan material, utilized it for vastly different purposes and had not applied it in the microgram scale of the present invention. Their techniques were not directed toward and have not achieved the unique results of the present invention. Rather they have sought completely different results. For instance, U.S. Pat. Nos. 4,812,159 and 4,964,894 to Freepons each sought to utilize chitosan (deacetylated chitin) to change the growth of specific plants. Contrary to the goals of the present invention, these references were aimed at altering a plant's natural growth and development; they also involved applying chitin at levels thousands of times greater than the present invention. Similarly, the present invention takes an entirely different approach from that disclosed in U.S. Pat. No. 4,940,040 to Suslow, in which genetically-altered bacteria were placed near a plant. The resultant man-made bacterial strains of Suslow took an entirely different direction from the organic approach of the present invention. Perhaps most illustrative of the vastly different directions taken by some is contained in U.S. Pat. No. 4,670,037 to Kistner. Somewhat like the Suslow reference, this reference involved intentionally placing a fungus near certain plants. Again it is directed away from the direction of the present invention as it is the separate organism, not the propagule, which accomplished the desired result. The Kistner reference also did not address the need for disease control; instead it might be characterized as tempting fate (let alone regulatory requirements) by purposefully placing a fungus near the plant.

While there has unquestionably been a long-felt need to control diseases for field crops, this need has not been completely satisfied, even though the implementing substances and elements of the present invention had long been available. The inability of those skilled in the art to view the problem from the perspectives of the present inventors has, perhaps, been in part due to the fact that prior to the present invention those skilled in the art had not fully appreciated the nature of the problem. Rather than considering the possibility of an organic solution to the problem, the acute nature of the problem may have caused those skilled in the art to focus upon the pesticide approach mentioned earlier. They apparently had not fully appreciated that the problem of disease control could be achieved through organic natural means of induced systemic resistance and innate immunity. While substantial attempts had been made by those skilled in the art to achieve disease control, the mechanism that is the underpinning of the present invention as well as the results, which it has been able achieve, have not fully been understood.

Rather than taking the approach of utilizing a substance that stimulates the propagule's own natural defensive mechanisms, those skilled in the art actually taught away from this direction by utilizing an external substance which in itself controls the disease. Perhaps especially with respect to the present invention, the results, which have been achieved, have been somewhat unexpected. Those skilled in the art had utilized similar substances on similar propagules without the ability to achieve the results of the present invention. This has been attended by some degree of disbelief and incredulity on the part of those skilled in the art. However, by expanding the fundamental understanding of the mechanisms within the plant itself, the present invention may not only convince those skeptical of its approach, it may also drive further progress in this area.

U.S. Pat. No. 5,726,123 to Heinsohn et al. teaches the use of a mixture of chitosan oligomers and chitosan salt to plants to increase yields. This reference is incorporated herein in its entirety to the extent it does not teach away from the present invention.

U.S. Pat. No. 6,972,285 B2 to Chang is directed to a method of preparing concentrated aqueous slurry solutions of a polyglucosamine, such as chitin or chitosan, and adding copper for use as fungal control agents.

U.S. Pat. No. 5,554,445 to Struszczyk and Kivekas is directed to a method for seed encrusting with a film coating of liquid polymer dispersion of microcrystalline chitosan as a seed encapsulant.

U.S. Pat. No. 6,589,942 B1 to Ben-Shalom and Pinto is directed to chitosan metal chelate complexes as a method for controlling fungal and bacterial diseases in plants.

U.S. Pat. No. 5,965,545 to Ben-Shalom and Platt is directed to compositions and methods for controlling-fungal and bacterial diseases in plants using a combination of chitosan and beta-glucosamine.

### III. SUMMARY OF THE INVENTION

The present invention utilizes techniques that provide primary recognition of microbe- or pathogen-associated-molecular-patterns (MAMPs/PAMPs/elicitors) by receptors (specific proteins embedded in cellular membranes) and signal transduction (a process internal to the cell) to induce natural physiological processes. The focus of the invention is the suppression of plant environmental stresses and pathogens, diseases and pests, including parasitic nematodes, blue stain molds and pine beetles that infect many crops and trees under field conditions.

As used herein, the term “elicitor” means the following. Elicitors are stimuli of biotic and abiotic types. For example, the latter are represented by natural stresses to the plant from touch, shear forces (wind), temperature shocks and osmotic stresses. Biotic elicitors include glucan polymers, glycoproteins, low molecular weight organic acids, fungal xylanases and cell wall materials and segments of bacterial flagella. High affinity binding sites have been characterized for oligo-β-glucosides, such as oligochitins, oligochitosans, yeast N-glycan and β-1,4-linked galacturonate oligomers. The stimuli are perceived by receptors on the plant cell surface, which lead to activation of second messengers that transmit signals in the cell and throughout the plant. Although there are numerous MAMPs/PAMPs/elicitors perceived by plants, very few pattern recognition receptors have been characterized. Among these, one RLK CERK1 is recognized in the perception of chitin and chitosan, which by way of signal transduction pathways ultimately result in gene expression and the biochemical changes that benefit the plant. Signaling molecules also regulate entire pathways by factors, which influence signal transduction pathways. These factors include polyamines, calcium, jasmonates, salicylates, nitric oxide and ethylene.

As used herein, the term “propagule” refers to any material from which a plant or crop can grow and contains genetic information for the metabolism, development and eventual replication of cells. Examples of propagules include, but are not limited to plants, cuttings, grafts, seedlings, roots, tubers, or any other plant material which contains genetic information for growth and development. A “pregermination propagule” refers to a propagule which has not yet germinated, such as a seed, for example.

The present invention discloses both the fundamental understandings and some specific arrangements that achieve a level of organic disease control for a propagule. The present invention also discloses arrangements, which can achieve enhancement of emergence and yield for propagules. The present invention further discloses arrangements, which increase the subsequent growth rate. The disclosed arrangement permits the goals of disease control, enhanced emergence and yield to be achieved individually or in combination. In its preferred embodiment, the invention involves a system including seed treatment of the propagule. In an embodiment, “a system” includes an elicitor. This elicitor seed treatment may include an intense stimulus, or elicitor, such as chitin. In addition, chitosan may also be used. While chitosan is not strictly an organic substance, it provides many of the advantages, albeit to different degrees, as chitin. The solubilized form of chitin and chitosan, which is a component of the chitin and chitosan and micronutrient trace elements of the present invention, is an intense stimulus that is not only non-damaging to the propagule, but also acts through various means to cause the propagule itself to release an amount of naturally defensive substance(s). Naturally defensive substances may, of course, include both substances that the propagule naturally is capable of synthesizing and secreting, as well as those naturally defensive substances that may be produced as a result of biotechnological manipulations, for which the gene(s) for such substances are introduced into the genetic material of plants.

The naturally defensive substance may be internalized or released regardless of whether there is any disease present and is kept within the vicinity of the propagule, so it is available when needed. Importantly, the naturally defensive substance is sufficient to disable or destroy the ability of the disease to negatively impact the propagule. The invention also encompasses techniques for varying the system to accommodate a great variety of specific propagules, diseases, and needs. Because the disease is disabled, there is a positive impact on the growth of the propagule. The propagule is allowed to naturally develop free from the effects of the disease. In this fashion, a very natural result is achieved. The system may thus assure an organically grown, naturally developed product.

Accordingly, it is an object of the invention to achieve a natural and effective method for disease control for organized living cells. This includes propagules of those members of the plant kingdom that are of commercial interest. Thus, a goal is to avoid the use of chemicals such as pesticides, to avoid any genetic changes within the propagule itself, and to utilize the plant's own defensive capability in achieving disease control. In keeping with this general goal, a more specific goal is to provide an insulated impact on the plant. Thus, one goal is to allow an external stimulus to trigger the propagule's own processes and achieve disease control. Similarly, another goal is to avoid any change in the natural growth development of the propagule. The present invention avoids any genetic changes and merely triggers the propagule's own natural processes. A further goal is to allow the plant to develop naturally and not have any changes except that of keeping the disease from negatively impacting the propagule's development. Thus, a goal is to allow the plant to grow naturally without either a positive or a negative impact on its own developmental cycles. Another broadly stated goal of the present invention is to provide a protection which lasts until the propagule has developed sufficiently to do without that protection. In keeping with this goal the present invention affords treatments, which may exist over several months until that propagule has matured. Naturally, this is achieved while avoiding any utilization of potentially harmful substances.

Yet another general goal of the invention is to minimize the impact on the growing environment. Thus, the invention concentrates its effects at the most important location, near the propagule. This may reduce field application costs, and may avoid the residual impacts of using a broadly applied substance. In order to achieve this specific goal, it is a goal to avoid any application of the end disease control substance. Rather the goal is to utilize a naturally occurring intermediate substance that triggers the plant to achieve its own disease control.

An additional general goal of the invention is to utilize propagule treatments to enhance plant emergence and yield of plant product. Specifically, it is a goal to use propagule seed treatment to enhance emergence and/or foliar or irrigation treatments to enhance yield separately or in addition to disease control, which in the literature is referred to as induced systemic resistance and innate immunity.

A further goal is to develop a system which can enhance propagule growth separately or in combination with disease control or enhancement of emergence, increase flowering, fruiting and yield.

A further object of the invention is to incorporate regulatory, unknown, and psychological factors, which lead to broad commercial acceptance. Thus, the invention has as a goal the utilization of naturally occurring substances to cause the triggering of the effect within the tissue itself. This is achieved through an insulated approach whereby a stimulus acts through several different mechanisms before causing the existence of the naturally defensive substance. Thus, the placement of unnatural, potentially harmful, or otherwise unnecessary substances near the propagule is completely avoided. In keeping with this goal, it is an object of the invention to afford advantages to the grower, who is charged with actually implementing the system.

It is a still further object of the present invention to provide a method for controlling pathogens, disease and pests in field crops that incorporates applying a substance to the foliage of a propagule.

It is a still further object of the present invention to provide a method for controlling pathogens, disease and pests in field crops which incorporates applying a substance to the soil wherein a propagule is planted.

It is a still further object of the present invention to provide a method for controlling pathogens, disease and pests in field crops which incorporates treating the seed of the crop with a substance.

It is a still further object of the present invention to provide a substance which can be applied to the foliage of propagule of a field crop which causes the propagule to produce a naturally defensive substance against disease.

It is a still further object of the present invention to provide a substance which can be applied to the soil in which a propagule of a field crop is planted which causes the propagule to produce a naturally defensive substance against disease. It is a still further object of the present invention to provide a substance which can be applied to the seed of a field crop which causes the propagule emerging from the seed to produce a naturally defensive substance against disease.

It is a still further object of the present invention to provide a substance which can be applied in any combination of the above to a field crop for controlling either pathogens, disease and pests or for production of naturally defensive substances against disease.

Additionally, the chitin and chitosan and micronutrient trace elements of the present invention operates as a homeopathic chemical engine. As such it operates as follows:

Contact of the chitin and chitosan and micronutrient trace elements of the present invention with receptors on the plant cell surface initiate signal transduction pathways, which either elevate or diminish expression of certain enzymes. These enzyme activities may promote the following processes:
1. Plants produce various secondary metabolites that allow interaction with the environment. Elicitors can enhance these and/or second messenger development. The interplay of elicitors, secondary metabolites and second messengers enables the plant to better overcome biotic and abiotic (environmental) stresses through a process known as signal transduction.
2. Interplay of the signaling molecules important to nematodes, rhizobia and mycorrhiza (microorganisms) interaction is represented by a class of compound called flavonoids.
3. The plants make flavonoids to signal these microorganisms.
4. These microorganisms may make nod-factors, which dictate specificity between plant roots and nematodes, rhizobia or mycorrhiza.
5. Nod-factors contain chitin oligosaccharide components. This might be a common element with the composition of the chitin and chitosan and micronutrient trace elements of the present invention.
6. The process of making the chitin and chitosan and micronutrient trace elements of the present invention might yield some flavonoid mimics.
7. The chitin and chitosan and micronutrient trace elements of the present invention may therefore contain elements necessary for both sides of the interaction, i.e. for the signaling from the plant and the specificity from the microorganisms.

The chitin and chitosan and micronutrient trace elements of the present invention do not control nematodes. Rather an elicitor of plant induces suppressants of nematodes and other pathogens. As such growth of parasitic nematodes in the vicinity of the developing propagule or seed is suppressed without harming beneficial nematodes. The elicited output of the chemical engine via signal transduction and growth properties suppresses the parasitic nematode. In contrast, methyl bromide destroys both beneficial nematodes and parasitic nematodes, as well as rhizobial and microrhizal microbial forms, which are extremely beneficial to the nutrition of plants, particularly leguminous plants. Methyl bromide is extremely harmful to humans and the environment and is expected to be prohibited by the EPA.

An additional feature of the chemical engine is its ability to improve crop quality in the presence of other field borne pathogens. See data from Mexico, set forth herein below.

Treatments of the chitin and chitosan and micronutrient trace elements of the present invention have reduced by as much 10 kilograms per hectare of dangerous chemical pesticides on potatoes.

Crops suitable for use with the present invention include, but are not limited to: legumes including soybeans, as well as wheat, canola, corn, rice, peanut, tobacco, sugar beet, sunflower, pepper, tomato, fruit, flowers, vegetables, grass, citrus, conifer, potato, and sweet clover.

Naturally, further objects of the invention are disclosed throughout other areas of the specification and claims.

### IV. BRIEF DESCRIPTION OF THE DRAWINGS

FIG. 1 shows comparisons of germinating mung beans elicitation following seed treatment with chitin and chitosan and micronutrient trace elements of the present invention.

FIG. 2 shows comparisons of germinating adzuki beans elicitation following seed treatment with various concentrations of chitin and chitosan and micronutrient trace elements of the present invention.

### V. DETAILED DESCRIPTION OF THE INVENTION

The chitin and chitosan and micronutrient trace elements of the present invention is an all-natural plant amendment derived from chitin and chitosan and is 100% water soluble, whereas chitin and chitosan is not water soluble. Chitin and chitosan occurs naturally in a range from 100% chitin to 100% chitosan as a mixed polymer. By contrast, an NMR analysis of the chitin and chitosan and micronutrient trace elements of the present invention revealed characteristics of approximately 20% chitin and approximately 80% chitosan. Below are data showing that the chitin and chitosan and micronutrient trace elements of the present invention outperforms chitin and chitosan as an elicitor of self-protecting enzymes.

One of the classical responses to elicitation of plants is induction of certain enzyme activities. These may
1. Enhance seed germination by increasing enzymes for degradation of polymers in the seed,
2. Promote and elevate seedling vigor to boost stand quality and health, which establishes root systems earlier with more foliage, to stimulate production of greater yields,
3. Make available agents (e.g. enzymes and phytoalexins) that resist growth of bacteria, fungi, fight pathogens and compromise parasitic nematodes,
4. Develop chemical engines that stimulate advanced mechanisms to overcome environmental stresses, e.g. mineral imbalances, hail, drought or wind, insect and pathogen damage, and
5. Delay senescence by suppression of ethylene action, which allows more complete product development

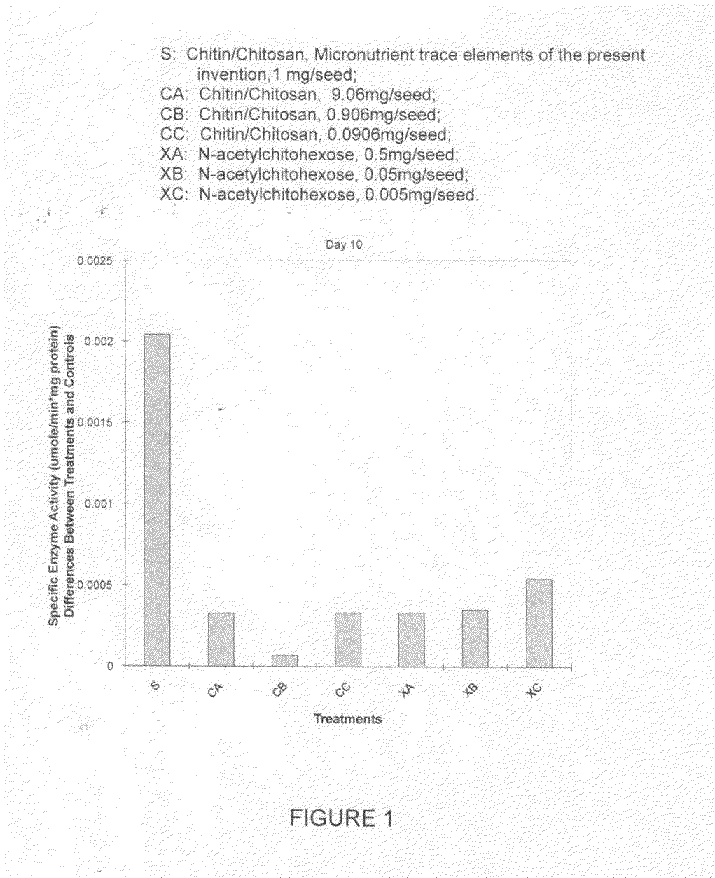

Enzyme activity measurements relate to the level of a given enzyme protein in the plant tissue. As an example of enhanced enzyme activity, β-1,3-glucanase was measured. The enzyme, β-1,3-glucanase, was assayed using laminarin (a soluble β-1,3-glucan) as substrate. Crude homogenates of the seedlings from treated seeds yielded the data in FIG. 1. Increased β-1,3-glucanase activity compared to controls (without seed treatment) was obtained in the chitin and chitosan and micronutrient trace elements of the present invention treatments ten days following germination. Elicitation of mung beans seeds that were treated with the chitin and chitosan and micronutrient trace elements of the present invention were compared to those treated with two types of elicitors. First, various concentrations of purified colloidal chitin and chitosan were used. The dose response to chitin and chitosan concentrations of 9, 0.9 and 0.09 mg/seed followed no regular pattern. A nearly equivalent concentration of the chitin and chitosan and micronutrient trace elements of the present invention (1 mg/seed) elicited five times as much β-1,3-glucanase enzyme activity. Secondly, lower concentrations of the chitin oligosaccharide containing six glycan moieties, N-acetylchitohexaose, were studied. The importance of the chitin oligosaccharide is that short chains of chitin have been found optimal in elicitation of many types of plants. The dose response relationship to the oligosaccharide concentrations of 0.5, 0.05 and 0.005 mg/seed was negative; i.e. higher doses resulted in lower specific enzyme activities. Comparisons similar to those with chitin and chitosan could be made between the performance of 1 mg/seed chitin and chitosan and micronutrient trace elements of the present invention and lower concentrations of the more optimal oligosaccharide.

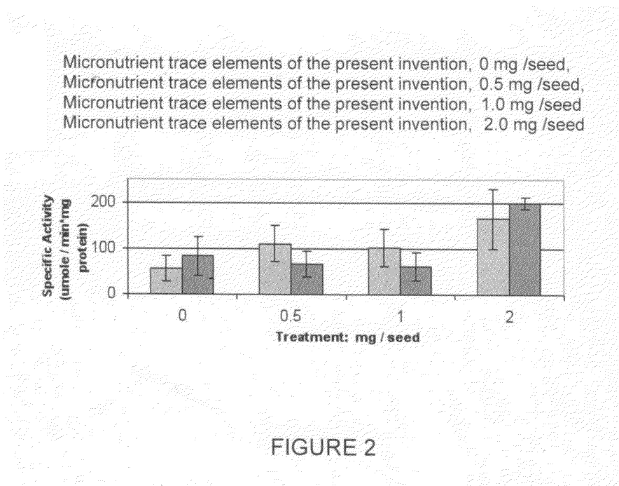

A dose response for the chitin and chitosan and micronutrient trace elements of the present invention in induction of elevated β-1,3-glucanase activity in adzuki beans is demonstrated by data in FIG. 2. Induction of this enzymatic activity increases with quantity of chitin and chitosan and micronutrient trace elements of the present invention applied to the seeds. Comparison of elicitation between treatments with 0, 0.5, 1.0 and 2.0 mg/seed and controls in specific enzyme activity was evaluated in both hypocotyl and epicotyl tissues. The specific enzyme activities in both tissues increased with dosage 21 days after germination. The differences become significant in root tissue using 2.0 mg/seed with twice the level of activity, compared to controls.

See FIG. 1. FIG. 1 shows differences between controls and seed treatments with the chitin and chitosan and micronutrient trace elements of the present invention, chitin and chitosan and N-acetylchitohexaose oligosaccharide on specific activities of β-1,3-glucanase in homogenates of mung bean seedlings ten days after germination in test tubes in the presence of said quantities. It is also significant that this enzyme activity aids seed germination by breaking down the polymer in the aleuronic layer, which separates the endosperm and germ. The sugars mobilized by amylases in the endosperm are better able to diffuse to the growing plantlet emerging from the germ.

See FIG. 2. FIG. 2 shows specific activities of β-1,3-glucanase in homogenates of adzuki bean shoot tissue (blue) and root tissue (red) twenty-one days after germination in test tubes of water controls and those of treatments in the presence of various concentrations of micronutrient trace elements of the present invention. Whereas such measurements of β-1,3-glucanase were made, the literature has shown coordinated expression of this enzyme activity with that of chitinase also increases with seed treatments of milk-vetch, soybean, radish, rice and black pine tree. Chitinase activity is a key factor inhibiting infection of fungal pathogens by enzymatic hydrolysis of fungal cell walls.

Elicitors are quite different than plant growth regulators and plant hormones, which include auxins, gibberillic acid, cytokinins and ethylene. Methyl jasmonate (MJ) is generally known to induce secondary metabolite formation in plants and is considered an elicitor.

Homeopathic natural elicitors are of the biotic and abiotic types. Abiotic elicitors are represented by natural stresses to the plant from touch, shear forces (wind), temperature shocks and changes in osmotic conditions caused by numerous environmental variables.

Biotic elicitors include glucan polymers, glycoproteins, low molecular weight organic acids and fungal cell wall materials. High affinity binding sites for oligosaccharins have been characterized: oligo-β-glucosides such as oligochitins, oligochitosans, yeast N-glycan and β-1,4-linked galacturonate oligomers (degree of polymerization greater than ten that form egg-box complexes with millimolar concentrations of calcium ions). In submicromolar concentrations these elicitors change plant cell morphology, ion balances in plant cells, oxidative burst formation and phytoalexin accumulation. Some of these elicitors induce defense responses, but there are other types of responses, such as increases in dry biomass weight, root size, stem caliper, bloom and harvest yield. The field results, which our agriculture industry partners have obtained with chitin and chitosan and micronutrient trace elements of the present invention (a soluble oligo-chitin and chitosan elicitor), statistically demonstrate the advanced capabilities of the non-damaging stimulus. At the time of the initial patent filling, the mechanism of elicitation was not understood and still our research continues to help us further understand these natural processes.

The homeopathic elicitor end-products are comprised of relatively large numbers of high and low molecular weight soluble chains of oligo-chitin and -chitosan. One mL contains over 100,000 trillion (10¹⁵) active chitin and chitosan molecules with micronutrient trace elements.

The present invention is based upon the mix rate of chitin and chitosan and micronutrient trace elements of the present invention that is delivered to the propagule. The scientific literature is replete with examples that show the effective chitin and chitosan elicitors are constituents of low molecular weight components with degrees of polymerization (DP) of 4 through 9).

The EPA has granted the inventors of the present invention registration label number 83729-1 for active agent comprising of 0.25% chitin and chitosan. The effective concentration of the DP 4 through DP 9 oligosaccharides (Active Ingredient) with an average molecular weight of 1100 has been determined experimentally to be 285 micromolar, which calculates to 0.03% (w/v) of Active Ingredient in the elicitor preparation. These effective elicitor oligosaccharides represent approximately 10% of the mix rate (0.25%). When the manufactured product is diluted for delivery to the propagule as seed treatment, the chitin and chitosan and micronutrient trace elements of the present invention is applied at different rates depending upon seed size (surface area per kg seed) as shown in Table 1. The smaller the relative seed areas require lower application rates of the chitin and chitosan and micronutrient trace elements of the present invention to initiate the signal transduction response.

Set forth in Table 1 are microgram quantities per propagule for soybean, broccoli, mustard and potato minituber of 5 g weight and diameter of 1 cm. These propagules were chosen as examples because of experience of the inventors. Because of their spherical geometry, it was convenient to calculate the surface area of each. For each example the basis for comparison is that used experimentally, which is 0.85 microgram of chitin and chitosan and micronutrient trace elements of the present invention elicitor per gram of soybean seed.

TABLE 1
Application rates of the chitin and chitosan and micronutrient elicitor of the
present invention is dependent on propagule surface areas: SA = surface area

| | Seed Size | Surface | | Surface | | Elicitor | Elicitor |
|---|---|---|---|---|---|---|---|
| Seed | (mm | Area | Seed | area | Elicitor | (g per kg | (μg per |
| crops | diameter) | (m²/seed) | number/kg | (m²/kg) | (mL/kg) | propagule) | propagule) |
| Soybean | 4 | 5.0 × 10⁻⁵ | 907 | 0.05 | 0.0029 | 8.5 × 10⁻⁷ | 0.000937 |
| broccoli | 1 | 3.1 × 10⁻⁶ | 45,351 | 0.14 | 0.0089 | 2.7 × 10⁻⁶ | 0.000059 |
| mustard | 0.2 | 1.3 × 10⁻⁷ | 454,545 | 0.06 | 0.0036 | 1.1 × 10⁻⁶ | 0.000002 |
| potato | 10 | 3.1 × 10⁻⁴ | 200 | 0.06 | 0.0039 | 1.2 × 10⁻⁶ | 0.005857 |
| minituber | | | | | | | |

| | | Surface | assumed | | | | |
|---|---|---|---|---|---|---|---|
| | Needle wt | area (m²) | needle | Surface | | Elicitor | Elicitor |
| Conifer | (g) of ten | of ten | number | area | Elicitor | (g per kg | (μg per |
| trees | count | count | per tree | (m²/kg) | (mL/kg) | propagule) | propagule) |
| ponderosa | 0.096 | 4.2 × 10⁻⁴ | 100000 | 4.4 × 10⁻⁶ | 2.8 × 10⁻⁷ | 8.2 × 10⁻¹¹ | 0.0790 |
| pine | | | | | | | |
| blue | 0.0085 | 5.0 × 10⁻⁵ | 100000 | 5.9 × 10⁻⁶ | 3.7 × 10⁻⁷ | 1.1 × 10⁻¹¹ | 0.0094 |
| spruce | | | | | | | |
| lodgepole | 0.0105 | 7.8 × 10⁻⁵ | 100000 | 7.4 × 10⁻⁶ | 4.6 × 10⁻⁷ | 1.4 × 10⁻¹¹ | 0.0140 |
| pine | | | | | | | |

Round seeds, which can be approximated as having spherical geometry, can be used for comparison: For soybean seeds with a nominal diameter of 4 mm, the surface area (SA) can be calculated using the following formula:

SA=πd²=π(0.004m)²=0.00005m².

A pound of soybean seed of the given size nominally contains 2000 seeds and as a unit, the

SA=2000seeds/lb*0.00005m²/seed=0.1m²/lb or 0.05m²/kg.

For broccoli seeds with a diameter of 1 mm, SA=0.00000314 m², but as a unit of 100,000 seeds/pound,

SA=0.314m²/lb or 0.14m²/kg.

For mustard seeds with a diameter of 0.2 mm,

SA=0.00000013m², but as a unit of 1,000,000seeds/pound,

SA=0.314m²/lb or 0.13m²/kg.

With these three examples, it is apparent that smaller seed have greater surface area per unit weight than do larger counterparts.

The counterparts can be compared because all three have smooth, glassy surfaces that would absorb similar amounts of liquid per unit surface area in a seed treatment. Comparing types of seed of similar size, but with different surface textures could not be considered counterparts. A rough porous seed coating would potentially absorb more Active Ingredient than seed with smooth, glassy surfaces.

An extension of the following may be considered if the moisture content of the seeds under consideration is different than the examples considered above. For instance, the 5 gram minituber seed potato that is 90% water would have a lower seed count per pound than would soybean seed.

Because the exteriors of the conifer needles have similar smooth, glassy surfaces, as does the soybean seed, foliar application rates to trees in control of pine beetles and blue stain molds have been calculated on the basis of experience with commercial seed treatments of soybeans. Again, the basis for calculation was the surface area per kg of needles from each of the tree species studied. Foliar application of the chitin and chitosan and micronutrient trace elements of the present invention is assumed for treatment of trees, to which 100,000 needles are coated sufficiently by the spray to impact at least a minimum number of pattern recognition receptors in the cellular membranes of the needles.

Similarly, application of the diluted invention of the chitin and chitosan and micronutrient trace elements composition would exhibit micronutrient ranges as follows:

TABLE 2
Analysis reveals the chitin and chitosan and micronutrient trace elements
of the present invention comprises the following components

| | micro- | | | | |
|---|---|---|---|---|---|
| | nutrient | percent | grams/mL | g/g seed | μg/g seed |
| Total | N | 0.28 | 0.0028 | 8E−09 | 0.0080 |
| NH₄ | N | 0.14 | 0.0014 | 4E−09 | 0.0040 |
| H₂O sol | N | 0.28 | 0.0028 | 8E−09 | 0.0080 |
| Urea | N | <0.5 | 0.005 | 1.4E−08 | 0.0143 |
| H₂O sol | K | <0.1 | 0.001 | 2.9E−09 | 0.0029 |
| H₂O sol | Ca | 5.00% | 0.0005 | 1.4E−09 | 0.0014 |
| H₂O sol | P | <0.1 | 0.001 | 2.9E−09 | 0.0029 |
| H₂O sol | S | <0.1 | 0.001 | 2.9E−09 | 0.0029 |
| H₂O sol | Cl | 0.07% | 0.00069 | 2E−09 | 0.0020 |
| H₂O sol | Fe | <0.1% | 0.0001 | 2.9E−10 | 0.0003 |

For irrigation treatment, application on the order of 0.1 to 20.0 mL chitin and chitosan and micronutrient trace elements per gallon of water is a suitable concentration and use of about one pint of this mixture per acre is sufficient to protect most crops. The same concentration of about 0.1 to 20.0 mL chitin and chitosan and micronutrient trace elements per gallon of water is a suitable concentration for foliar treatment as well as a seed dip. Use of the chitin and chitosan and micronutrient trace elements of the present invention as an irrigation or foliar treatment provides contact of the chitin and chitosan and micronutrient trace elements with receptors on the plant cell surface, which initiates signal transduction pathways that result in defense responses and enhanced vigor of seedlings. These processes lead to earlier and more robust root systems, earlier and more robust foliage, which together provide more development in the growth period and eventually produce greater crop yields.

The signal transduction brought about by contact of the chitin and chitosan and micronutrient trace elements of the present invention with cell surface receptors on a plant further enhance growth and crop yield by inducing the plant to generate protective enzymes and phytoalexins for resistance to bacteria, fungi, entomologic attack, other pathogens and suppression of parasitic nematodes.

The signal transduction brought about by contact of the chitin and chitosan and micronutrient trace elements of the present invention with cell surface receptors on a plant further enhance growth and crop yield by allowing the plant to stimulate chemical engines, which enhance the ability of the plant to withstand and overcome environmental stress such as mineral imbalances, hail, drought, wind and pathogenic and entomologic stresses.

The signal transduction brought about by contact of the chitin and chitosan and micronutrient trace elements of the present invention with cell surface receptors on a plant further enhance growth and crop yield by increasing the effective growing period by delaying senescence, thereby allowing more complete crop development before harvest.

Use of the chitin and chitosan and micronutrient trace elements of the present invention as a seed treatment enhances seed germination by increasing the rate of germination, as well as the proportion of seeds germinating by increasing enzyme activity, such as β-1,3-glucanase, for example, which degrades polymers in the seed. The site of this enzyme activity resides in the aleurone cells, which is a layer of cells between the endosperm and germ of the seed.

Additionally, the present invention does not demonstrate a negative physiological impact on field crops. Crops are not hurt by the elicitation or suffer physiological damage or impairment of growth. Only positive results have been observed. Thus, the effect of present invention in this manner behaves in a positive manner.

Signal transduction that results in either positive or negative regulation can be elicited each acting independently or dependently of one another. In cell biology these concepts are referred to as up-regulation, down-regulation and signaling crosstalk. Chemical engines result in a wide range of physiological enhancements as well as defending, resisting and overcoming environmental, disease and nematode pressures.

Repeated application of the invention can cause sequential cascading signal transduction activations for greater power of the chemical engines.

### Seed Treatment Applications Affecting Nutrient Uptake and Nematode Assays

Set forth in Table 3 are supporting data regarding micronutrient trace elements concentrations analyzed in the tissues of soybeans, which were conducted at the Central Illinois Agricultural Research Farms, Inc., 1229 W. Edwards, Springfield, Ill. 62704-1634. This experiment was conducted at the Henry White Experimental Farm, Field 4, Sep. 1, 2005, Lab. No. 25109 and 25106. Analyses were composite samples from four replications.

TABLE 3
Soybean Tissue Micronutrient Analysis Results and Comments
Percent

| | N | P | K | Ca | Mg | S |
|---|---|---|---|---|---|---|
| 4T | 2.92 | 0.24 | 0.92 | 1.54 | 0.25 | 0.18 |
| 4C | 2.99 | 0.24 | 0.98 | 1.42 | 0.23 | 0.16 |

PPM

| | B | Zn | Mn | Cu | Fe | Al | Na |
|---|---|---|---|---|---|---|---|
| 4T | 44 | 35 | 88 | 7 | 55 | 175 | 31 |
| 4C | 40 | 30 | 78 | 5 | 71 | 81 | 22 |

Comments: The most limiting nutrient is Iron (Fe). Eight of the micronutrient balance ratios out of 40 are good. The average deviation is 129 for the treated soybeans and 125 for the control. The deviation is high and indicates that several nutrients are out-of-balance and/or this is a disease scenario. The Becker Nematode Index (BNI) is 83 and 103, respectively for treatments and controls. The higher BNI in the control suggests that there are more nematode problems in those strips. Nematode assays, which are set forth in Table 4, were conducted after harvest. The treatment was using one pint per acre of the chitin and chitosan and micronutrient trace elements of the present invention with four replications in a paired comparison design.

TABLE 4
Nematode Counts, Total and Parasitic, per 100 mL of
soil from the Henry White Experimental Farm Field 4.

| | Total | Total | Parasitic | Parasitic |
|---|---|---|---|---|
| Replication | Treated | Control | Treated | Control |
| 1 | 336 | 904 | 40 | 96 |
| 2 | 368 | 312 | 40 | 96 |
| 3 | 416 | 512 | 56 | 120 |
| 4 | 472 | 664 | 40 | 88 |
| Average | 398 ns | 598 ns | 44* | 100* |

ns = no significant difference,
*significantly different at the 99% confidence level

The strips of the soybean rows that were treated with the chitin and chitosan and micronutrient trace elements of the present invention averaged 11.0% parasitic nematodes. The control strips averaged 16.7% parasitic nematodes. The two most common parasitic nematodes were lance and lesion. Yield losses can be expected when parasitic levels are higher than 10%.

Soil profile examinations showed compaction problems between 3 and 12 inches deep. Root development was restricted and yields were affected. Control strips averaged 52.2 bushels per acre and the treated strips averaged 53.4 bushels per acre.

A review of the above data shows that the plant signal transduction defense response induced by the chitin and chitosan and micronutrient trace elements of the present invention suppressed the establishment of harmful parasitic nematodes.

Following application of the present invention to sugar beet seed by film coating and bioassays for cyst nematodes (Heterodera schachtii) in glass houses in the Netherlands by Sesvander have, effects in supression of the number of cyst nematodes were observed on sugar beet plants treated with chitin and chitosan and micronutrient trace elements of the present invention. Set forth in Table 5 are bioassay results, which indicate a reduction in the number of cysts in the nematode susceptible hybrid. Bioassay results from water treatment of a tolerant hybrid are given for comparison.

TABLE 5
Average values for the number of cysts found from replicated bioassays
when seeds of a cyst susceptible hybrid were treated with various
dilutions of the chitin and chitosan and micronutrient trace elements
of the present invention prior to planting.

| invention applied | Tolerant or | Average number |
|---|---|---|
| (g per 100 mL) | susceptible | of cysts |
| 0 | susceptible | 82 |
| 0 | tolerant | 53 |
| 0.6 | susceptible | 63 |
| 1.2 | susceptible | 75 |
| 2.4 | susceptible | 74 |

### Pine Trees & Conifer Pest Control

The active agent, the chitin and chitosan and micronutrient trace elements of the present invention, has been tested on wide vary of conifers including loblolly pine, lodge pole, fir, spruce, and ponderosa pine (Knutson 2010) to induce a systemic response against pine beetles and innate immunity against blue stain mold. USForest Service research using EPA Reg. No 83729-1 to control pathogens in pine trees and the ability of the chitin and chitosan and micronutrient trace elements of the present invention to increase pine tree resin pitch outflow by 40% is hypothesized to resist southern pine beetle infestation. The presence of the chitin and chitosan and micronutrient trace elements of the present invention induced a systemic response that elicits 40% increase in pine resin pitch which traps the pine beetle from infecting the pine trees. At this elevated level the elicitation of the pine resin pitch-out would result in a 37% reduction in pine beetle eggs. EPA Reg. No 83729-1 was applied at rate of 80 mL into 5 to 10 gallons of water as a foliar spray (P=0.10%) and soil treatment (P=0.01%) under the drip ring of the trees. Other forestry researchers have identified chitosan to induce changes in mono-terpenes and di-terpene acid levels in pine resin pitchout. They have identified the gene expression of chitosan responsible for disease resistance in slash pine and a reduction of blue stain mold in southern pines.

The chitin and chitosan and micronutrient trace elements of the present invention works across species. Three years of field trials using ponderosa pine under epidemic mountain pine beetles infestation elicited defense responses that increased tree survival rate two-fold (200%). Treated trees exhibited increased pine resin pitch flow, which forces the boring female beetle out of the trees. The third year treated trees had a 60% survival rate. Untreated ponderosa pines exhibited resin pitchout flow rates that allowed the pine beetle entry. Untreated trees had a 20% survival rate. Trees treated with chitin and chitosan and micronutrient trace elements of the present invention exhibited few pine beetle attacks, as well. The ponderosa pine replicated study data were analyzed using MSTAT30 (Michigan State University), showing a statistical difference of the induced systemic response against mountain pine beetle infestation as set forth in Tables 6 and 7 under replicated conditions.

TABLE 6
Tree viability of treated ponderosa pines vs untreated
(control) after 3 years of epidemic pine beetle infestation:
2011 ANOVA2 averages from scoring criteria for tree survival
statistics (Red Feather Lakes, Colorado).

| Original | Survival | | Ranked | Survival | | |
|---|---|---|---|---|---|---|
| Order | Rating | | Order | Rating | | Treatments |
| Mean 1 | 2.90 | A | Mean 1 | 2.90 | A | Mean 1: 1x treatment |
| Mean 2 | 2.90 | A | Mean 2 | 2.90 | A | Mean 2: 2x treatment |
| Mean 3 | 1.80 | B | Mean 3 | 1.80 | B | Mean 3: untreated (control) |

Application Rates: 1x treatment: 1 mL in 5 gal/tree; 2x treatment: 2 mL in 5 gal/tree
Function: RANGE: Data case no. 1 to 30 without selection; n = 10
Duncan's Multiple Range Test: s_ = 0.3491418 at alpha = 0.05 x
Scoring averages basis: 4 = healthy; 3 = alive; 2 = dying; 1 = dead

TABLE 7
Pine beetle entry sites number counted on treated
Ponderosa Pine vs untreated trees: 2011 ANOVA2 averages
for beetle entry sites per tree statistics.

| Original | Entry | | Ranked | Entry | | |
|---|---|---|---|---|---|---|
| Order | Sites | | Order | Sites | | Treatments |
| Mean 1 = | 4.80 | B | Mean 2 = | 12.70 | A | Mean 1: treated |
| Mean 2 = | 12.70 | A | Mean 1 = | 4.80 | B | Mean 2: untreated |
| | | | | | | (control) |

Application rates: treated: 1 mL in 5 gal/tree; untreated: control
Function: RANGE: Data case no. 1 to 20 without selection; n = 10
Duncan's Multiple Range Test s_ = 2.597961 at alpha = 0.10 x

### Vegetables and Flowers

Increased disease resistance due to the homeopathic bioactive chitin and chitosan and micronutrient trace elements of the present invention elements results in increased germination and harvest yields in vegetables and flowers in greenhouses.

### Seed Viability

It is a common practice for farmers hold over seed from year to year. Seed germination rates are important to a successful stand and harvest. Storage of seed over time degrades the seed viability, which reduces the germinate rate. Until this invention, farmers had a saying you can't make old seed good again. A further feature of the invention is the chitin and chitosan and micronutrient trace elements elicit seed to increase seed vitality.

Set forth in Table 8 are seed viability data from a seed treatment with the chitin and chitosan and micronutrient trace elements of the present invention on two year old sweet corn seed resulted in an 11% increase in germination rate.

TABLE 8
Seed treatment viability report on 2-year old corn conducted by
STA Labs using application rate of application rate of chitin and
chitosan and micronutrient trace elements of the present invention
of 4 fluid ounces acre tested according to AOSA guidelines.

| Seed | | |
|---|---|---|
| Viability** | Untreated | Invention* |
| Day 9 | 64% | 71% |

Set forth in Table 9 under replicated conditions are germination rates for vegetables grown under controlled conditions in a greenhouse located at Colorado State University. Treatment using the chitin and chitosan and micronutrient trace elements of the present invention had a 12% to 33% increase in seed germination over the untreated controls. Data represents number of germinated seeds per pot. Three seeds were planted in each of three pots and irrigated every three days with a solution containing 1 of chitin and chitosan and micronutrient trace elements of the present invention per gallon. Controls were similarly irrigated with water only.

TABLE 9
Seed germination rates for peas, broccoli, lettuce
and spinach in Colorado State University greenhouse

| | Control | | Treatment | | Germination |
|---|---|---|---|---|---|
| | 12.Mar | 15.Mar | 12.Mar | 15.Mar | % increase |
| Peas | 2 | 2 | 2 | 2 | |
| | 2 | 2 | 3 | 3 | |
| | 2 | 2 | 3 | 3 | |
| Total | 6 | 6 | 8 | 8 | 33.0% |
| Broccoli | 3 | 3 | 3 | 3 | |
| | 1 | 1 | 3 | 3 | |
| | 3 | 3 | 2 | 2 | |
| Total | 7 | 7 | 8 | 8 | 14.2% |
| Lettuce | 3 | 3 | 3 | 3 | |
| | 2 | 2 | 3 | 3 | |
| | 3 | 3 | 3 | 3 | |
| Total | 8 | 8 | 9 | 9 | 12.5% |
| Spinach | 3 | 3 | 3 | 3 | |
| | 1 | 1 | 3 | 3 | |
| | 3 | 3 | 3 | 3 | |
| Total | 7 | 7 | 9 | 9 | 28.5% |

Set forth in Table 10 are yields for field grown vegetables and flowers grown under replicated conditions in Mexico. Data showed a 12% to 110% increase in yields of crops treated with chitin and chitosan and micronutrient trace elements of the present invention over the untreated controls.

Field Grown Chili Peppers var. “Grande” (Mexico)

Seeds were planted in a shade house and the plantlets were immersed before transplanting at an application rate of 1 liter of the chitin and chitosan and micronutrient trace elements of the present invention per hectare.

Field Grown Onions var. “Diamante” (Mexico)

Onions were grown using drip irrigation. Treatment was applied 1 month after planting using 1 liter of the chitin and chitosan and micronutrient trace elements of the present invention in 10 liters of water per hectare.

### Field Grown Flowers (Mexico)

Marigold treatments were by seed treatment. The seed was inoculated with 300 mL of chitin and chitosan and micronutrient trace elements of the present invention on the seeds used per hectare. The seeds were dried before planting. The harvest was supervised by the technical department of the factory “productos deshidratados de mexico”, makers of β-carotene.

TABLE 10
Yields for field grown chili peppers,
onions and marigolds in Mexico

| | Control | Treatment | Percent |
|---|---|---|---|
| Crop | MT/ha | MT/ha | increase |
| Chili peppers | 3.6 | 7.6 | 110.0 |
| Onions | 25.3 | 28.33 | 12.0 |
| Marigolds | 9.7 | 12.7 | 30.6 |

### Greenhouse Flowers

Set forth in Table 11 are yields for greenhouse grown flowers grown under replicated conditions in Italy. Data was collected from controlled greenhouse trials on roses and chrysanthemums by Biopsherea Co, Taviano, Italy. Data showed a 13% to 41% increase in yields using the chitin and chitosan and micronutrient trace elements of the present invention compared to the untreated controls. Application rates (weekly for 13 weeks) were 1 mL of chitin and chitosan and micronutrient trace elements of the present invention per 3.4 sq.m. of table space.

TABLE 11
Yields for fresh cut long stem roses and chrysanthemums in Italy
Fresh cut long stem Roses

| Harvest | Non-treated | Treated 1 ml | |
|---|---|---|---|
| Day | control | per 3.4 sq m | |
| 21 | 2 | 3 | |
| 22 | 1 | 3 | |
| 23 | 5 | 9 | |
| 24 | 10 | 12 | |
| 25 | 13 | 14 | |
| 26 | 11 | 14 | |
| 27 | 15 | 16 | |
| 28 | 16 | 18 | |
| 29 | 18 | 18 | |
| 30 | 16 | 19 | |
| 31 | 18 | 22 | |
| 32 | 15 | 15 | |
| 33 | 11 | 10 | |
| 34 | 6 | 11 | |
| 35 | 13 | 14 | |
| 36 | 11 | 15 | |
| 37 | 2 | 11 | |
| 38 | 6 | 14 | |
| 39 | 5 | 13 | |
| 40 | 1 | 7 | |
| 41 | 2 | 9 | |
| 42 | 0 | 7 | |
| 43 | 0 | 3 | |
| 44 | 1 | 3 | |
| Total Yield | 198 | 280 | |
| % Increase | | | 41% |

Set forth in Table 12 are germination rates for flowers grown under controlled conditions in greenhouses located at Colorado State University. Data showed a 200% to 350% increase in seed using the chitin and chitosan and micronutrient trace elements of the present invention over the untreated controls. Data represents number of germinated seeds per pot in each of three pots in which three seeds were planted on 6. March and irrigated every three days using 1 mL of chitin and chitosan and micronutrient trace elements of the present invention per gallon of water. Controls were similarly irrigated with water only.

TABLE 12
Seed germination rates for zinnias and marigolds
in Colorado State University greenhouse

| | Control | | Treatment | | |
|---|---|---|---|---|---|
| | 12. Mar | 15. Mar | 12. Mar | 15. Mar | % increase |
| Zinnias | 2 | 2 | 2 | 2 | |
| | 0 | 0 | 3 | 3 | |
| | 0 | 0 | 2 | 2 | |
| | 0 | 1 | 2 | 2 | |
| Total | 2 | 2 | 9 | 9 | 350.00% |
| Marigolds | 0 | 0 | 2 | 3 | |
| | 0 | 0 | 2 | 3 | |
| | 3 | 3 | 2 | 3 | |
| Total | 3 | 3 | 6 | 9 | 200.00% |

### Seed Treatment Applications Resulting in Field Yield Enhancements Corn

The chitin and chitosan and micronutrient trace elements of the present invention when applied as a seed coating works across plant species in food crops to enable plants to increase root biomass under a wide range of soil types. Set forth in Table 13 are yield data from corn grown under a variety of field conditions following seed treatment using a 3 mL application rate of chitin and chitosan and micronutrient trace elements of the present invention for planting a total of seven acres of corn by EMD Crop Bioscience (Novozymes).

TABLE 13
EMD Crop Bioscience (Novozymes) yield data from three
corn varieties grown under different field conditions

| Corn | | Control | Invention |
|---|---|---|---|
| Variety | Location | Bu/acre | Bu/acre |
| Agri-Tech | Whitewater WI | 163.5 | 169.4 |
| Agri-Tech | Whitewater WI | 142.5 | 141.4 |
| Midwest | York, NE | 201.1 | 219.8 |
| Midwest | Osceola, NE | 192.2 | 190.7 |
| Viger | Fergus City, MN | 141.2 | 143.1 |
| Agri Tech | Whitewater | 162.1 | 165.8 |
| Agri Tech | Whitewater | 193.5 | 202.3 |
| Midwest | Osceola | 170.2 | 170.7 |
| Midwest | York, NE | 210.7 | 225.7 |

| | |
|---|---|
| Control Mean | 175.2 |
| Treatment Mean | 181.0 |
| P(x) | 0.0421 |
| Response (Bushels per Acre) | 5.8 |
| Response (% of Control) | 3% |
| Positive Response (%) | 78% |
| N | 9 |

The chitin and chitosan and micronutrient trace elements of the present invention in combination with Optimize in solutions for seed treatments on corn, as set forth in Table 14, indicated enhancement of yields at two Indiana locations compared to controls and Optimize alone.

TABLE 14
Comparisons of corn yields from seed treated with chitin and
chitosan and micronutrient trace elements of the present invention
against and with fungicides and inoculants commonly used in
agriculture The effects of the chitin and chitosan and micronutrient
trace elements of the present invention as a seed treatment
with Optimize inoculants on Corn Seed - Yield (Bu/A). field
trial by Tryon Group Trial 07LF4C (Variety - 108 RM RoundUp)
and EMD Crop Bioscience (Novozymes)

| HYBRID Corn | | Percent |
|---|---|---|
| Seed Treatment | Bu/Acre | Change |
| | Elnora, IN | |
| Untreated | 201.6 | |
| Optimize | 219.2 | 8.7% |
| Yea! + Optimize | 228.5 | 13.3% |
| | Roanoke, IN | |
| Untreated | 152.3 | |
| Optimize | 165.6 | 8.7% |
| Yea! + Optimize | 172.7 | 13.4% |

### Soybean

Commodity crops in greenhouse and field studies demonstrated increased yield using seeds treated and/or irrigated with chitin and chitosan and micronutrient solutions of the present invention. Set forth in Table 15 are greenhouse data on soybean yields conducted at Colorado State University. This data shows a combination of the chitin and chitosan and micronutrient trace elements elicitor of the present invention seed treatment and a foliar treatment had a 49% increase in yield.

Also set forth below in Table 16, also shown are yield data from field studies using the same treated seed as described in Table 15.

TABLE 15
Colorado State University soybean greenhouse studies. The greenhouse
manager supervised pot filling, seeding, fertilization, insect
management, watering and crop harvest/clean-up. EMD provided DSR
221/RR soybean seed both untreated and treated with 1.25 mL of
a 5 mL/gallon dilution of the invention/lb of seed. Two staggered
irrigation applications of the invention were applied using a 1.5
mL/gallon dilution of the invention (100 mL/pot) to treatments
B and D; irrigations of treatments A and C were with an equivalent
volume of water. Seed size was statistically the same for all four
treatments (0.17 g/seed), as was the case for plant emergence (90
percent). Mean seed weights per plant were statistically significant
using Duncan's Multiple Range Test at p = 0.05. Data with
different letters were statistically significant.

| treat- | no. of | total g | g seed per | percent | significance |
|---|---|---|---|---|---|
| ment | plants | seed | plant | increase | p = 0.05 |
| A | 94 | 50.8 | 0.54 | | C |
| B | 86 | 59.4 | 0.69 | 27.9 | CB |
| C | 93 | 69.7 | 0.75 | 38.6 | B |
| D | 89 | 71.8 | 0.81 | 49.2 | A |

Treatment A control, untreated seed, water irrigations;
Treatment B untreated seed with two irrigated applications of invention;
Treatment C treated seed, water irrigations;
Treatment D treated seed with two irrigated applications of invention.

TABLE 16
Field yield data from replicated results for soybeans,
corn and wheat. Seed treatments using only 1.25 mL/lb of seed of a 5
mL/gallon dilution of chitin and chitosan and micronutrient trace
elements of the present invention. Field studies were conducted by
EMD Crop Bioscience (Novozymes).
Seed Treatments
date: Dec. 7, 2005 Units: bu/acre

| | Soybean | % increase | Corn | % increase | Wheat | % increase |
|---|---|---|---|---|---|---|
| treated | 63.9 | | 225.7 | | 50.4 | |
| control | 61.7 | | 210.7 | | 47.9 | |
| delta | 2.2 | 3.57% | 15 | 7.12% | 2.5 | 5.22% |

Set forth in Table 17 are yield data from soybeans grown under a variety of field conditions following seed treatment using a 3 mL application rate of chitin and chitosan and micronutrient trace elements of the present invention on seed for planting a total of seven acres of soybeans by EMD Crop Bioscience (Novozymes).

TABLE 17
EMD Crop Bioscience (Novozymes) yield data from one soybean
variety grown under different field conditions

| Soybean | Control | Invention |
|---|---|---|
| Location | Bu/acre | Bu/acre |
| Whitewater. WI | 55.5 | 58.0 |
| Whitewater. WI | 63.4 | 66.6 |
| York, NE | 66.3 | 66.2 |
| Osceola, NE | 63.4 | 66.2 |
| Whitewater WI | 37.7 | 43.3 |
| MREC A4 | 49.1 | 53.7 |

| | |
|---|---|
| Control Mean | 55.9 |
| Treatment Mean | 59.0 |
| P(x) | 0.0120 |
| Response (Bushels per acre) | 3.1 |
| Response (% of Control) | 5% |
| Positive Response (%) | 83% |
| N | 6 |

The compatible nature of the invention provides for its use in integrated pest management with fungicides and inoculants in solutions for seed treatments on soybeans, as set forth in Tables 18 and 19. The use of chitin and chitosan and micronutrient trace elements of the present invention alone yielded approximately 1 Bu/acre more than the control and in combination with Vault, about 1.5 Bu/acre more than the control. Optimize alone had a negative effect on yield, but in combination with the invention, the yield was greater than the invention alone.

TABLE 18
Comparisons of soybean yields from seed treated with chitin
and chitosan and micronutrient trace elements of the present
invention against and with fungicides and inoculants commonly
used in agriculture. Benefits of the invention as a seed treatment
with fungicides and inoculants on Soybean Seed - Yield (Bu/A)
conducted by Tryon Group (USA), Trial 07LFC3D was conducted
in Roenoke, IN with three reps per treatment.

| SOYBEAN | Roanoke, IN | percent |
|---|---|---|
| Seed Treatments | Bu/Acre | increase |
| Untreated Control | 45.05 | |
| YEA | 46.01 | 2.13% |
| Yield Shield + YEA | 45.98 | 2.06% |
| Optimize + YEA | 46.26 | 2.69% |
| Vault + YEA | 46.68 | 3.62% |
| ApronMaxx RFC + YEA | 45.62 | 1.27% |

TABLE 19
Incotec (Brazil) investigated nodulation, germination, plant height and the yield of
grains in Brazil using the chitin and chitosan and micronutrient solutions of the present
invention on Round-up Ready Soybeans in 2009. Treatments included (1) raw seeds as
control and (4) a basic pesticide chemical treatment along with a Disco L322 seed coating
applied @ 0.875 ml kg/seeds. Dilution Disco:additive (50:1); the additive was the
chitin and chitosan and micronutrient solution of the present invention.

| | Objects | Plot A | Plot B | Plot C | Plot D | Total | Average | | C.V. |
|---|---|---|---|---|---|---|---|---|---|
| Nodulation | 1 | 125 | 109 | 98 | 103 | 435 | 109 | a | 22.49% |
| | 4 | 128 | 115 | 114 | 119 | 476 | 119 | a | |
| Seed weights | 1 | 1.738 | 1.76 | 1.32 | 1.76 | 6.578 | 1.644 | a | 33.52% |
| | 4 | 2.893 | 1.991 | 1.342 | 1.859 | 8.085 | 2.021 | a | |
| Plant height | 1 | 39.6 | 39.6 | 39.5 | 42.3 | 161 | 40.65 | a | 4.51% |
| | 4 | 39.9 | 39.9 | 44.9 | 40.6 | 165.3 | 41.66 | a | |
| Germination | 1 | 17 | 27 | 29 | 18 | 93 | 23.25 | a | 19.65% |
| | 4 | 23 | 30 | 32 | 20 | 103 | 25.75 | a | |

### Rice

Set forth in Table 20 are yield data of rice grown under a variety of field conditions following seed treatment with the chitin and chitosan and micronutrient solution of the present invention using a 3 mL application rate of chitin and chitosan and micronutrient trace elements of the present invention on seed for planting a total of seven acres of rice by EMD Crop Bioscience (Novozymes).

TABLE 20
EMD Crop Bioscience (Novozymes) yield data from
one rice variety grown under two field conditions

| Rice | Control | Invention |
|---|---|---|
| Location | Lbs/acre | Lbs/acre |
| Shoffner, AR | 7506.0 | 8707.5 |
| Louisiana | 5505.5 | 6025.8 |

| | |
|---|---|
| Control Mean | 6505.8 |
| Treatment Mean | 7366.7 |
| Response (lb/A) | 860.9 |
| Response (% of Control) | 13% |
| N | 2 |

### Sugar Beets

Set forth in Table 21 are yield data of sugar beets grown under one field condition following seed treatment with the chitin and chitosan and micronutrient solution of the present invention using a 1.3 mL per liter application rate of chitin and chitosan and micronutrient trace elements of the present invention for treating a total of 100 kg of sugar beet seed by Agvise Research Inc (Northwood, N. Dak.) for EMD Crop Bioscience (Novozymes).

TABLE 21
Agvise for Crop Bioscience (Novozymes) yield data from
one sugar beet variety grown in one field location

| Sugarbeet | | |
|---|---|---|
| Seed | Control | ODC |
| Location | Tons/acre | Tons/acre |
| Agvise | 13.1 | 14.6 |

| | |
|---|---|
| Response(tons/A) | 1.5 |
| Response (% of Control) | 11% |

SES Vanderhave (Belgium) studied the germination of sugar beet seed as impacted by the chitin and chitosan and micronutrient solution of the present invention to find improvement in germination rates comparable to the water treated controls in both normal and primed seed, as set forth in Table 22.

TABLE 22
Effect of concentration of the chitin and chitosan and
micronutrient solution of the present invention on germination
rates of primed and unprimed sugar beet seed.

| | |
|---|---|
| concentration | % germination after 2 days |

| of invention | unprimed | primed |
|---|---|---|
| (mL/100 mL water) | seed | seed |
| 0 | 41 | 87 |
| 0.3 | 70 | 93 |
| 0.6 | 68 | 93 |
| 1.2 | 64 | 90 |
| 2.4 | 61 | 91 |

### Cotton

The invention works to bioactivate non-food crops, such as cotton lint harvest yields. Set forth in Table 23 are yield data from cotton seed treatment using a 1.3 per liter application rate of chitin and chitosan and micronutrient trace elements of the present invention for planting a total of 100 kg of cotton seed by EMD Crop Bioscience (Novozymes).

TABLE 23
Lint yield data from one cotton variety grown under a variety
of field conditions (EMD Crop Bioscience (Novozymes) data)

| N | | 6 |
|---|---|---|
| Seed | | Invention |
| Location | Control | 1 L/100 kg |
| Lonoke, AR | 667 | 699 |
| Shoffner, AR | 1043 | 1011 |
| *Groom, TX | 844 | 852 |
| *Wellington, TX | 903 | 948 |
| Chula, GA | 1020 | 1033 |
| Tifton, GA | 616 | 603 |

| | |
|---|---|
| Control Mean | 848.9 |
| Treatment Mean | 857.6 |
| P(X) | 0.4833 |
| Response (lb lint/A) | 0.0 |
| Response (% of control) | 726% |
| Positive response (%) | 67% |

A further benefit of the chitin and chitosan and micronutrient solution of the present invention is its ability enhance crop yields in locales outside of the USA.

| conc. of | | | | | |
|---|---|---|---|---|---|
| invention | | AVG | AVG | AVG | AVG |
| (mL/100,000 | | BELG | FRAN | BELG | FRAN |
| seed) | hybrid | % S | % S | WSY | WSY |
| 0 | Nem tol | 100.4 | 100.1 | 103.9 | 99.3 |
| 8 | Nem tol | 101.5 | 100.7 | 103.9 | 99.8 |
| 16 | Nem tol | 100.8 | 100.4 | 106.1 | 99.3 |
| 0 | Nem | 98.7 | 99.2 | 94.9 | 101.2 |
| | susc | | | | |

### Sugar Beet

The quality of sugar beets was measured as both percent sugar and white sugar yields by treatment of the seed with the chitin and chitosan and micronutrient solution of the present invention by SES Vanderhave (Belgium) in Belgium and France. Compared to the water treated controls in both nematode-susceptible and -tolerant seed varieties, data set forth in Table 24 indicate general improvement in the percent sugar and in the white sugar yields using treated seed.

TABLE 24
Effect of sugar beet seed treatment using the chitin and chitosan
and micronutrient solution of the present invention on from beets
treated of nematode-susceptible and -tolerant sugar beet seed.
Data represents averages of analyses from three locations in each
country. No other crop protectants were added during coating. Rates
of application during film coating. 0 = Control; 8 =
(8 mL/U of 100,000 seeds); 16 = (16 mL/U of 100,000 seeds).

| | | | | | |
|---|---|---|---|---|---|
| 8 | Nem susc | 99.8 | 99.4 | 96.8 | 100.7 |
| 16 | Nem susc | 99.4 | 99.6 | 95.0 | 101.0 |

Trials were conducted by the University of Agricultural Sciences, Dharwad India. The invention was applied as a seed coating on soybean, maize, wheat and lentils at an application rate using a 3 mL for planting a total of seven acres of each type of seed. Data from these trials are set forth in Tables 25 through 28 and demonstrate yield improvements of from 3 to 40 percent using chitin and chitosan and micronutrient trace elements of the present invention as a seed treatment, compared to controls.

### Soybean

TABLE 25
Yield data from soybean field trials grown using two
varieties under different field conditions in India
INDIA 2009 SOYBEAN seed treament field trials

| | | | | % Yield |
|---|---|---|---|---|
| Variety | Control | Invention | variance | Increase |
| 3 | 2.55 | 3.85 | 1.3 | 51% |
| 1 | 2.72 | 4.07 | 1.35 | 50% |
| 3 | 3.68 | 4.95 | 1.27 | 35% |
| 1 | 3.55 | 4.82 | 1.27 | 36% |
| 3 | 3.48 | 4.79 | 1.31 | 38% |
| 1 | 3.08 | 4.03 | 0.95 | 31% |
| 3 | 3.33 | 4.67 | 1.34 | 40% |
| 3 | 3.47 | 4.58 | 1.11 | 32% |
| 3 | 2.56 | 3.88 | 1.32 | 52% |
| 3 | 2.71 | 3.97 | 1.26 | 46% |
| 3 | 2.68 | 3.85 | 1.17 | 44% |
| 3 | 2.66 | 3.82 | 1.16 | 44% |
| 3 | 2.61 | 3.69 | 1.08 | 41% |
| 3 | 3.36 | 4.78 | 1.42 | 42% |
| 3 | 3.47 | 4.89 | 1.42 | 41% |
| 3 | 3.56 | 4.78 | 1.22 | 34% |
| 3 | 2.68 | 3.88 | 1.2 | 45% |
| 3 | 2.81 | 3.78 | 0.97 | 35% |
| 3 | 3.78 | 4.68 | 0.9 | 24% |
| 1 | 2.82 | 3.41 | 0.59 | 21% |
| 3 | 3.42 | 4.56 | 1.14 | 33% |
| 3 | 3.09 | 4.18 | 1.09 | 35% |
| 3 | 2.95 | 3.88 | 0.93 | 32% |
| 3 | 3.06 | 3.98 | 0.92 | 30% |
| | 74.08 | 101.77 | 27.69 | 910% |
| | | Average | | 40% |

### Corn

TABLE 26
Yield data from maize field trials grown using three varieties in India
India MAIZE 2009

| | | | | Total | | % |
|---|---|---|---|---|---|---|
| | | kg | kg | kg | Difference | Increase |
| 1) Viraj D. Bhosale. Umbergaon | | | | | | |
| maize variety Pioneer 30v92 | quintal | 2400 | 93 | 2493 | 477 | 23.66% |
| | Invention | | | | | |
| | control | 2000 | 16 | 2016 | | |
| date of sowing 30 Jul. 2009 | | | | | | |
| harvesting 25th Nov. 2009 | | | | | | |
| 2) Keshav P. Bhosale Umbergaon | | | | | | |
| Maize Variety Kaveri | Invention | 2300 | 68 | 2368 | 330 | 16.19% |
| | control | 2000 | 38 | 2038 | | |
| date of sowing 1st Aug. 2009 | | | | | | |
| harvesting 27th Nov. 2009 | | | | | | |
| 3) S [symbol] Bhosale Valadg [symbol] | | | | | | |
| Maize variety - Teck | Invention | 2400 | 57 | 2457 | 321 | 15.03% |
| untreated | | | | | | |
| 21 quintal 36 kg | control | 2100 | 36 | 2136 | | |
| date of sowing 27 Jul. 2009 | | | | | | |
| harvesting 23th Nov. 2009 | | | | | | |
| | | | | | Average | 18.29% |

[symbol]

indicates data missing or illegible when filed

### Wheat

TABLE 27
Yield data from wheat field trials grown
under different field conditions in India

| | Control | Invention | | % |
|---|---|---|---|---|
| Crop | MT/A | MT/A | Variance | improvement |
| Wheat | 11.68 | | −11.68 | −100.0% |
| Wheat | 11.49 | 12.47 | 0.98 | 8.5% |
| Wheat | 12.87 | 14.25 | 1.38 | 10.7% |
| Wheat | 12.35 | 13.69 | 1.34 | 10.9% |
| Wheat | 11.15 | 12.20 | 1.05 | 9.4% |
| Wheat | 11.15 | 12.20 | 1.05 | 9.4% |
| Wheat | 13.05 | 14.45 | 1.40 | 10.7% |
| Wheat | 11.70 | 12.47 | 0.77 | 6.6% |
| Wheat | 11.39 | 12.78 | 1.39 | 12.2% |
| Wheat | 12.17 | 14.05 | 1.88 | 15.4% |
| Wheat | 11.58 | 12.77 | 1.19 | 10.3% |
| Wheat | 11.77 | 12.40 | 0.63 | 5.4% |
| Wheat | 11.35 | 12.69 | 1.34 | 11.8% |
| Wheat | 11.09 | 12.55 | 1.46 | 13.2% |
| Wheat | 11.35 | 12.09 | 0.74 | 6.5% |
| Total | 176.14 | 181.06 | 4.92 | 2.8% |

### Lentils

TABLE 28
Yield data from lentil field trials grown
under different field conditions in India

| | Control | Invention | | % |
|---|---|---|---|---|
| Crop | MT/A | MT/A | Variance | improvement |
| Lentil | 4.75 | 5.68 | 0.93 | 16.4% |
| Lentil | 4.90 | 5.57 | 0.67 | 12.0% |
| Lentil | 3.79 | 4.68 | 0.89 | 19.0% |
| Lentil | 3.83 | 4.73 | 0.90 | 19.0% |
| Lentil | 3.77 | 4.53 | 0.76 | 16.8% |
| Lentil | 3.22 | 3.97 | 0.75 | 18.9% |
| Lentil | 3.57 | 4.38 | 0.81 | 18.5% |
| Lentil | 3.37 | 4.98 | 1.61 | 32.3% |
| Lentil | 4.70 | 5.68 | 0.98 | 17.3% |
| Lentil | 3.70 | 4.38 | 0.68 | 15.5% |
| Lentil | 4.70 | 5.68 | 0.98 | 17.3% |
| Lentil | 3.95 | 4.75 | 0.80 | 16.8% |
| Lentil | 3.80 | 4.55 | 0.75 | 16.5% |
| Lentil | 3.85 | 4.27 | 0.42 | 9.8% |
| Lentil | 4.61 | 5.22 | 0.61 | 11.7% |
| Total | 60.51 | 73.05 | 12.54 | 17.2% |

### Foliar Application Resulting in Field Yield Enhancements

An additional feature of chitin and chitosan and micronutrient trace elements of the present invention is its ability elicit greater harvest yields when applied in a dilute form such as a foliar spray applications.

### Corn

Set forth in Table 29 are yield data from foliar applications on corn crops with the invention at an application rate of 4 fluid ounces per acre of chitin and chitosan and micronutrient trace elements of the present invention conducted by EMD Crop Bioscience (Novozymes).

TABLE 29
Yield data from foliar spray applications on corn under various
soil conditions conducted by EMD Crop Bioscience (Novozymes)

| Corn | | |
|---|---|---|
| Foliar | Control | Invention |
| Location | Bu/acre | Bu/acre |
| Whitewater | 162.6 | 171.4 |
| Whitewater | 206.0 | 205.5 |
| Whitewater WI | 188.6 | 190.9 |
| Whitewater WI | 172.6 | 170.8 |
| Osceola, NE | 192.4 | 195.3 |
| York, NE | 216.7 | 221.4 |
| Fergus City, MN | 139.8 | 147.5 |

| | |
|---|---|
| Control Mean | 182.7 |
| Treatment Mean | 186.1 |
| P(x) | 0.0613 |
| Response (Bushels per Acre) | 3.4 |
| Response (% of Control) | 2% |
| Positive Response (%) | 100% |
| N | 7 |

### Soybeans

| | | |
|---|---|---|
| Foliar | Bu/acre | Bu/acre |
| Location | | |

Set forth in Table 30 are yield data from foliar applications on soybean crops with the invention at an application rate of 4 fluid ounces per acre of chitin and chitosan and micronutrient trace elements of the present invention conducted by EMD Crop Bioscience (Novozymes).

TABLE 30
Effects from foliar spray applications on soybean yields under various
soil conditions conducted by Crop Bioscience (Novozymes).

| Soybean | | |
|---|---|---|
| Foliar | Control | Invention |
| Location | Bu/acre | Bu/acre |
| Whitewater, WI | 56.2 | 62.8 |
| Whitewater, WI | 53.0 | 59.6 |
| Clinton Co., Ohio | 71.7 | 74.6 |

| | |
|---|---|
| Control Mean | 60.3 |
| Treatment Mean | 65.6 |
| Response (Bushels per acre) | 5.3 |
| Response (% of Control) | 8% |
| N | 3 |

### Peanuts

Set forth in Table 31 are presented yield data from foliar applications on peanut crops with the invention at a diluted to an application rate of 4 ml per acre of chitin and chitosan and micronutrient trace elements of the present invention.

TABLE 31
Effects of foliar spray applications on peanut yields under various
soil conditions conducted by EMD Crop Bioscience (Novozymes).

| Peanut | | |
|---|---|---|
| Foliar | Control | Invention |
| Location | Lbs/acre | Lbs/acre |
| Texas | 3773 | 3814.5 |
| Texas | 3785.5 | 3902.5 |
| Chula, GA | 4792 | 4792 |
| Tifton, GA | 5006 | 4998 |
| Headland, AL | 4835 | 5474 |
| Alabama | 1646 | 2208 |
| Alabama | 1627 | 1930 |

| | |
|---|---|
| Treatment Mean | 3874.1 |
| P(x) | 0.0604 |
| Response (lb/A) | 236.3 |
| Response (% of Control) | 6% |
| Positive Response (%) | 71% |
| N | 7 |

### Irrigation Application Resulting in Field Yield Enhancements

### Corn

It is well understood by field researchers that controlling water inputs to field crops can influence harvest yields. An additional feature of the invention is its ability elicit greater harvest yields when applied in a dilute form in irrigation water. Set forth in Table 32 are yield data from irrigation applications on corn crops with the invention at a rate of application rate of 4 fluid ounces acre of chitin and chitosan and micronutrient trace elements of the present invention.

TABLE 32
Yield data from irrigation applications on corn crops at
various locations with the invention at a rate of application
rate of chitin and chitosan and micronutrient trace elements
of the present invention of 4 fluid ounces acre conducted
by EMD Crop Bioscience (Novozymes).

| Corn | | |
|---|---|---|
| Furrow | Control | Invention |
| Location | Bu/acre | Bu/acre |
| Whitewater WI | 173.6 | 177.2 |
| Whitewater WI | 160.7 | 161.5 |
| York, NE | 206.5 | 217.3 |

| | |
|---|---|
| Control Mean | 80.3 |
| Treatment Mean | 185.3 |
| Response (Bushels per Acre) | 105.0 |
| Response (% of Control) | 57% |
| N | 3 |

### Soybeans

Set forth in Table 33 are yield data from irrigation applications on corn crops with the invention at a rate of application rate of 4 fluid ounces acre of chitin and chitosan and micronutrient trace elements of the present invention.

TABLE 33
Yield data from irrigation applications on soybean
crops at various location with the invention conducted
by EMD Crop Bioscience (Novozymes).

| Soybean | | |
|---|---|---|
| Furrow | Control | Invention |
| Location | Bu/acre | Bu/acre |
| Whitewater WI | 39.3 | 39.4 |
| Whitewater, WI | 56.2 | 62.8 |
| Whitewater, WI | 53.0 | 59.6 |
| Clinton Co., Ohio | 71.7 | 74.6 |
| Whitewater WI | 40.9 | 45.8 |
| Whitewater WI | 47.8 | 49.7 |

| | |
|---|---|
| Control Mean | 51.5 |
| Treatment Mean | 55.3 |
| P(x) | 0.0168 |
| Response (Bushels per acre) | 3.8 |
| Response (% of Control) | 7% |
| Positive Response (%) | 100% |
| N | 6 |

### Peanuts

Set forth in Table 34 are yield data from irrigation applications with the invention on peanut crops at a rate of application rate of 4 fluid ounces acre of chitin and chitosan and micronutrient trace elements of the present invention.

TABLE 34
Irrigation applications on peanuts yields conducted
by EMD Crop Bioscience (Novozymes).

| Peanut | | |
|---|---|---|
| Furrow | Control | Invention |
| Location | Lbs/acre | Lbs/acre |
| Alabama | 1646 | 2565 |
| Alabama | 1627 | 2541 |
| Control Mean | | 1636.5 |

| | |
|---|---|
| Treatment Mean | 2553.0 |
| Response (lb/A) | 916.5 |
| Response (% of Control) | 56% |
| N | 2 |

### Tomato

Set forth below in Table 35 are the results of an experiment in which a comparison of harvest yields between poorer and higher quality fields is shown. Under poor soil conditions for tomatoes found that treatment with the chitin and chitosan and micronutrient trace elements of the present invention yielded a 23.6% increase over control in poorer fields where soil and environmental conditions reduce output. In higher quality fields, under drip irrigation, where soil and environmental conditions produce higher output, treatment with the chitin and chitosan and micronutrient trace elements of the present invention yielded a 36.9% increase over control.

TABLE 35
Results on Tomato Yields from Field Studies conducted
by Bayer Crop Science (formerly Gustafson)

Tomato Variety: Heinz 9665
Drip irrigation
Harvest yield comparison in poorer and higher quality fields
Treatment Rate: 125 ml in 100 gallons per acre
Method: Foliar spray

| | Locations: | | | | | |
|---|---|---|---|---|---|---|
| | Cochoran, CA | | | Crows Landing, CA | | |
| | Soil Quality: | | | | | |
| | Poor | | | High | | |
| | Tons/acre | | % increase | Tons/acre | | % increase |
| Control | 41.5 | A | | 26.5 | A | |
| Treatment | 51.3 | B | 23.6% | 36.3 | B | 36.9% |

LSD = 0.05

Set forth below in Table 36 are the results of an experiment in fumigated fields, where soil conditions are sterile. Treatment with the chitin and chitosan and micronutrient trace elements of the present invention yielded a 56% increase in large tomatoes over control under drip irrigation.

TABLE 36
Results on Tomato Yields from Field Studies
conducted by Six L's Farm, Naples, FL

Variety: Roma
Drip irrigation Tomato Results in poorer quality fields
Location: Naples, FL
Application Rate: 1 pint per acre

| Tomato | Large 6 × 7 | Percent Increase | P = .05 |
|---|---|---|---|
| Control | 90 | | B |
| Treatment | 141 | 56% | A |

Note:
* Letters not the same indicate a statistical difference (P = .05)

### Potato

Set forth below in Tables 37 and 38 are the results of potato yields from fields in Mexico. In normal soil plants treated with the chitin and chitosan and micronutrient trace elements of the present invention had a 13.75% increase in daughter tuber yields over the control group.

TABLE 37
Results on Potato Yields from Field Studies
Farm: Free

| | Control | Treated with the Invention | |
|---|---|---|---|
| Reps | no of sacks* | no of sacks* | % increase |
| 1 | 98 | 139 | |
| 2 | 93 | 101 | |
| 3 | 95 | 90 | |
| 4 | 29 | 23 | |
| Total | 315 | 356 | 13.0% |

*50 kilograms/sack

TABLE 38
Results on Potato Yields from Field Studies
Farm: PEQA

| | Control | Treated with the Invention | |
|---|---|---|---|
| Reps | no of sacks* | no of sacks* | % increase |
| 1 | 140 | 160 | |
| 2 | 158 | 128 | |
| 3 | 135 | 97 | |
| 4 | 35 | 61 | |
| Total | 426 | 488 | 14.5% |

*50 kilograms/sack

Treated plants grown in infected soil had an average 7.9% increase in daughter tuber yield over the control group.

Set forth below in Table 39 are the results of an experiment on the fields of Sr. Ernesto Ortegon Cervera. The crop planted was potato, date of burning of the field was Nov. 27, 2001, date of sowing was Nov. 27, 2001, and the date of harvest was Apr. 4, 2002. The fields were irrigated by rolling irrigators and the fertilizer used was “Propia.” Ortegon is comprised of 0.5 parts Agrimicin, 1.0 part Confidor, 8.0 parts Pentaclor, 5.0 parts Temir and 0.6 parts Tecto 60. The cost of application on the Ortegon farm was $345.68 per hectare while the cost of application of the chitin and chitosan and micronutrient trace elements of the present invention was $175.03 per hectare. Yields using the present invention averaged 5.5 percent greater than that from fields treated conventionally.

TABLE 39
Comparison of potato yields between application of pesticide
mixture on the Ortegon farm and application of chitin and chitosan
and micronutrient trace elements of the present invention.
Farm: Ortegon

| | Pesticide mixture | Treated with the Invention | |
|---|---|---|---|
| Reps | No. of sack* | No. of sacks* | % increase |
| 1 | 267 | 237 | |
| 2 | 263 | 302 | |
| 3 | 150 | 172 | |
| 4 | 22 | 25 | |
| Total | 426 | 488 | 5.5% |

*50 kilograms/sack
Control group: applied chemicals/pesticide per manufacturer's recommendations.
Treated group: treated with 1 liter chitin and chitosan and micronutrient trace elements of the present invention/1000 liters of water/hectare.

Set forth below in Table 40 are the results of an experiment on the fields of Sr. Salvador Zazueta (Chava). The crop planted was 135 day Snowden (potato), date of burning of the fields was Apr. 8, 2001. date of sowing was Nov. 22, 2001, and the date of harvest was Apr. 18, 2002. The fields were irrigated by aspersion and the fertilizer used was “Propia.” Sr. Zazueta applied material to his crops which comprised 1.5 parts Fuvadan 350, 10.0 parts Captan, 5.0 parts Vitamin, 10.0 parts Carbovit, 0.15 parts giberellic acid and 0.8 parts Tecto 60. The cost of application of this mixture on the Zazueta farm was on the order of $265 per hectare while the cost of application of the chitin and chitosan and micronutrient trace elements of the present invention was $175.03 per hectare. Yields using the present invention averaged 2.7% percent greater than that from fields treated conventionally.

TABLE 40
Comparison of potato yields between application of pesticide
mixture on the Zazueta farm and application of chitin and chitosan
and micronutrient trace elements of the present invention.
Farm: Zazueta

| | Pesticide mixture | Treated with the Invention | |
|---|---|---|---|
| Reps | No. of sacks* | No. of sacks* | % increase |
| 1 | 276 | 262 | |
| 2 | 134 | 154 | |
| 3 | 30 | 36 | |
| Total | 440 | 452 | 2.7% |

*50 kilograms/sack
Control group: applied chemicals/pesticide per manufacturer's recommendations.
Treated group: treated with 1 liter chitin and chitosan and micronutrient trace elements of the present invention/1000 liters of water/hectare.

Set forth below in Table 41 are the results of an experiment on the fields of Sr. Enrique Free Pacheco. The crop planted was potato, date of burning of the fields was Mar. 7, 2001, date of sowing was Nov. 22, 2001, and the date of harvest was Apr. 4, 2002. The fields were irrigated by aspersion and the fertilizer used was “Propia.” Sr. Pacheco applied material to his crops which comprised 2.5 parts Manzate 200, 3.8 parts Cercobin M, 0.75 parts Coprimicin, 19.0 parts Pcnb 80 and 1.75 parts Nuvacron. The cost of application of this mixture on the Pacheco farm was $315.05 per hectare while the cost of application of the chitin and chitosan and micronutrient trace elements of the present invention was $175.03 per hectare. Yields using the present invention averaged 15.7 percent greater than that from fields treated conventionally.

TABLE 41
Comparison of potato yields between application of pesticide
mixture on the Pacheco farm and application of chitin and chitosan
and micronutrient trace elements of the present invention.
Units are in tons per hectare
Farm: Pacheco

| | Pesticide mixture | Treated with the Invention | |
|---|---|---|---|
| Reps | No. of sack* | No. of sacks* | % increase |
| 1 | 115 | 160 | |
| 2 | 83 | 75 | |
| 3 | 37 | 42 | |
| 4 | 9 | 11 | |
| Total | 279 | 323 | 15.7% |

*50 kilograms/sack
Control group: applied chemicals/pesticide per manufacturer's recommendations.
Treated group: treated with 1 liter chitin and chitosan and micronutrient trace elements of the present invention/1000 liters of water/hectare

### Grass

Set forth below in Table 42 are the results of an experiment conducted by the Department of Plant Pathology, Pennsylvania State University in July and August 2004, in which the control of gray leaf spot by the causative fungus Pyricularia grisea was studied. The application of chitin and chitosan and micronutrient trace elements of the present invention reduced the severity of the pathogen significantly 21 days following the final application of the pathogen.

TABLE 42
Evaluation of chitin and chitosan and micronutrient trace elements
of the present invention for control of Gray leaf spot on perennial
ryegrass in 2004. Treatment was applied three times at 14 day intervals,
the last being 14 days prior to first disease evaluation. P. grisea
spores suspension was applied two times at 14 day intervals, the
last being 14 days prior to first disease evaluation. Treatment
plots were arranged in a randomized complete block design with
three replications. The study was lightly irrigated and covered
nightly with plastic sheeting during the study.

| | | DISEASE | | DISEASE | |
|---|---|---|---|---|---|
| | APPLICATION | SEVERITY* | | SEVERITY* | |
| TREATMENT | RATE | 16 DAYS | | 21 DAYS | |
| Invention | 1.0 mL/1000 ft² | 4.0 | ab | 3.3 | bc |
| Control | None | 5.0 | a | 5.3 | a |

*Disease severity index 0-10: 0 = asymptomatic and 10 = 90% turf area symptomatic.
mean of three replications: values within columns with different letters are significantly different (p = 0.05) according to the Waller-Cuncan k-ratio test

### Disease & Pathogen Control

In agriculture, chitin and chitosan are used primarily as a natural seed treatment and plant growth enhancer, and as an ecologically friendly biopesticide substance that boosts the innate ability of plants to defend themselves against disease, fungal infections, pathogens and pests. Degraded molecules of chitin and chitosan exist in soil and water Chitosan increases photosynthesis, promotes and enhances plant growth, stimulates nutrient uptake, increases germination and sprouting, and boosts plant vigor.

The inventors have identified in the literature chitin and chitosan induced systemic resistance (ISR) and innate immunity in crops with specific reference to given disease, pathogens or pests, as set forth in the following list.

| Crop Name | Name of disease, pathogen, pest |
|---|---|
| Apple | Penicillium expansum |
| Apple | Botrytis cinerea and Penicillium expansum |
| Barley | F culmorum |
| Carrot | Sclerotinia sclerotiorum |
| Celery | Fusarium oxysporum |
| Citrus | Penicillium digitatum |
| Conifers | Ophiostoma minus |
| Grand fir | Bark Beetle |
| Grapes | Gray Mold |
| loblolly pine | Ophiostoma clavigerum |
| lodgepole pine | Ophiostoma minus |
| Lodgepole Pine | Ceratocystis clavigera |
| Norway spruce | Ceratocystis polonica (the bark beetle-associated |
| | bluestain fungus) |
| Oranges Lemons | Botrytis cinerea and Penicillium expansum |
| Peach | Botrytis cinerea, |
| Peanuts | Penicillum |
| Peas | Nectria haematocca |
| Peas | Fusarium solani |
| Pine | Dendroctonus ponderosoe (Mountain pine |
| | beetle (MPB)) |
| Pinus Nigra | Sphaeropsis sapinea and Diplodia scrobiculata |
| Potato | Penicillum |
| Potato | Verticillium |
| Potato | Fusarium, solani |
| Potato | Rhizoctonia |
| Potato | Erwinia |
| Potato | Nematode |
| Potato | Solanum tuberosum |
| Rye Grass | P. grisea |
| Sugar Beet | nematode |
| Slash Pine | Fusarium subglutinans f. sp. pini |
| Soybeans | Nematode |
| Strawberry | Phytophthora cactorum |
| Tomato | Cucumber mosaic virus |
| Tomato | Fusarium oxysporum f. sp. radicis-lycopersici |
| Tomato | Cladosporium fulvum |
| Tomato | Nematode |
| Western Pines | Ophiostoma minus |
| Wheat | F. culmorum |

It is also seen in citrus where the presence of the micro-nutrient trace elements of the present invention decreases ethylene production and increases sugar content. The chitin and chitosan and micronutrient trace elements of the present invention can also increase shelf life of citrus. Application of 16 oz per acre of the chitin and chitosan and micronutrient trace elements of the present invention to the crops, citrus resulted in 10% reduction in citrus decay in packing house resulting in 32% increase in juice grade yields after 5 days of storage.

With respect to the above description, it is to be realized that the optimum relationships for the components of the invention, to include variations in composition, proportion and manner of use, are deemed readily apparent and obvious to one skilled in the art, and all equivalent relationships to those described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact composition and operation shown and described, and accordingly, all suitable modifications and equivalents may be resorted to, falling within the scope of the invention.

1. A propagule planting system that controls diseases, pathogens and pests comprising:
a) a propagule which is selected from the group consisting of: soybean, corn, wheat, barley, sugar beet, oat, mustard, rice, legume, canola, peanut, sunflower, pepper, tomato and potato crops as well as vegetables, grass, flowers, fruit, citrus and conifer trees;
b) a non-damaging stimulus selected from a group consisting of chitin or chitosan or both and wherein said non-damaging stimulus is provided in the amount of approximately 1 to 250,000 micrograms for each gram of propagule and wherein said non-damaging stimulus is a stimulus which is not damaging to said propagule, and is provided such that the non-damaging stimulus is at a level in the range given above;
c) a chitin or chitosan or both as elicitor compositions in the range of 0-98% deacetylation comprised of the following micronutrient trace elements: total nitrogen 0.23-0.33%; ammoniacal nitrogen 0.11-0.16%; water soluble nitrogen, 0.23-0.33%; urea nitrogen 0.05-0.50%; water soluble potassium (K) 0.01-0.10%; calcium (Ca) 0.05%; available phosphate (PO₄) 0.01-0.10%; chloride (Cl) 0.07%; iron (Fe) 0.001-0.01%; and sulfur (S) 0.01-0.10%.
i) which sufficiently triggers the release of a naturally defensive substance from said propagule so as to protect said propagule from disease and so that said naturally defensive substance is at a greater level than would naturally exist, and
ii) which acts to at least sustain said release of said naturally defensive substance, and
wherein said non-damaging stimulus is also continuously provided in a non-gaseous form in a vicinity of said propagule; and
d) a non-gaseous communication medium wherein said medium allows said non-damaging stimulus to affect said propagule.

2. The propagule planting system of claim 1 for controlling diseases, pathogens, and pests wherein the non-damaging stimulus is continuously provided in a vicinity of said propagule and wherein said non-damaging stimulus causes the release of naturally defensive substances from said propagule and wherein said naturally defensive substance comprises chitinase, beta-1,3 glucanase, protease inhibitors, phenylalanine lyase, chitosanase, PR1 proteins, PR2 proteins, PR3 proteins, PR4 proteins; PR5 proteins or reactive oxygen species.

3. The propagule planting system of claim 1 that controls disease wherein said naturally defensive substance comprises chitinase, beta-1,3 glucanase, protease inhibitors, phenylalanine lyase, chitosanase, PR1 proteins, PR2 proteins, PR3 proteins, PR4 proteins, PR5 proteins or reactive oxygen species.

4. A propagule planting system that controls disease comprising:
a) a propagule selected from the group consisting of legumes including soybean, bean, pea, clover, as well as corn, wheat, sugar beet, barley, oat, rice, mustard, canola, peanut, sunflower, pepper, tomato, and potato crops as well as vegetables, grass, flowers, fruit, citrus and conifer trees;
b) a non-damaging stimulus selected from a group consisting of chitin or chitosan or both and wherein said non-damaging stimulus is provided in the amount of approximately 1 to 250,000 micrograms for each propagule and in a vicinity of said propagule; and
c) a communication medium wherein said medium allows said non-damaging stimulus to affect said propagule.

5. A chitin or chitosan or both elicitor in the range of 0-98% deacetylation comprised of the following micronutrient trace elements:
total nitrogen 0.23-0.33%; ammoniacal nitrogen 0.11-0.16%; water soluble nitrogen, 0.23-0.33%; urea nitrogen, 0.23-0.33%; urea nitrogen 0.05-0.50%; water soluble potassium (K) 0.01-0.10%; calcium (Ca) 0.05%; available phosphate (PO₄) 0.01-0.10%; chloride (Cl) 0.07%; iron (Fe) 0.001-0.01%; and sulfur (S) 0.01-0.10%.

6. The elicitor composition of claim 5 comprising 0.1 to 20 mL of the composition and further comprising 1 gallon of water, 0.0026 (v/v) to 0.52 (v/v) percent.

7. The elicitor composition of claim 6 applied to a propagule.

8. The composition of claim 7 wherein the application is foliar.

9. The composition of claim 7 wherein the application is irrigation.

10. The elicitor composition of claim 6 comprising 0.00000079% (w/v) to 0.00016% (w/v) of the composition and further comprising 1 gallon of water.

11. The method of claim 10 wherein the application is seed coating.

12. The method of claim 7 wherein the propagule is selected from the group consisting of legumes including soybean, bean, pea, clover, as well as corn, wheat, sugar beet, barley, oat, rice, mustard, canola, peanut, sunflower, pepper, tomato, and potato crops as well as vegetables, grass, flowers, fruit, citrus and conifer trees.
